(19) United States
(12) Patent Application Publication
(10) Pub. No.: US 2006/0064227 A1
(43) Pub. Date: Mar. 23, 2006

(54) Electronically managed LPG fumigation method and system

(75) Inventors: Brandon K. Uhde, El Paso, TX (US); Ezell R. Clarke, Las Cruces, NM (US); Stephen C. Masters, El Paso, TX (US); Douglas B. Waits, El Paso, TX (US)

Correspondence Address: FITCH EVEN TABIN AND FLANNERY, 120 SOUTH LA SALLE STREET, SUITE 1600, CHICAGO, IL, 60603-3406, US

(73) Assignee: Autotronic Controls Corporation

(21) Appl. No.: 10/945,413

(22) Filed: Sep. 20, 2004

(51) Int. Cl. F02D 41/14

(52) U.S. Cl. 701/104

(57) ABSTRACT

A system and method of controlling the rate of flow of supplemental fuel to an air intake received by an engine. The operating characteristics of an engine are sensed. An operational window is determined. The operational window defines the optimum operating characteristics of the engine. A memory storage device stores a control map. The control map defines an amount of supplemental fuel to add based upon ranges of operating characteristics of the engine. It is determined whether the sensed operating characteristics are within the optimum operating characteristics defined by the operational window. A control signal is formed to vary the rate of supplemental fuel flow through a trim valve based upon whether the sensed operating characteristics are within the window and according to the control map.

### FIELD OF THE INVENTION

The field of the invention relations to engine fuel delivery systems for motor vehicles and more particularly to LPG fumigation systems for diesel engines in motor vehicles.

### BACKGROUND OF THE INVENTION

Fumigation techniques are known to improve the power output and boost of an engine. In some situations, fumigation also increases the life of the engine, reduces fuel consumption, and decreases the noise produced by the engine.

In diesel engine fumigation systems, supplemental fuel that has been vaporized is placed into the intake stream of the engine. Specifically, a fuel vaporizer converts liquid fuel into a gas and another device, for instance, a venturi mixer, pulls the vaporized fuel into the main air intake of the engine for use by the engine. The fumigation process provides only a portion of the fuel used by the engine. The remainder of the fuel used by the engine may also be applied to the cylinders of the engine in the conventional manner.

Fumigation systems use various types of fuel as the supplementary fuel that is to be added to the engine. For instance, the supplementary fuel may be of the same type as the primary fuel. However, in many instances, the supplementary fuel is of a different form, for instance, in the form of liquid propane gas (LPG).

Previous fumigation systems add the supplementary fuel to the engine in either a proportional amount to engine boost or at a single preset fuel level. Consequently, previous systems are unable to take into account changes in engine in operating conditions. No feedback from the engine is provided so that the current conditions of the engine can not be used to alter the amount of supplementary fuel added or the timing of when this fuel is added. Because of these draw-backs, previous systems suffer from situations where the engine becomes over-boosted and over-revved. The over-boosting and over-revving of the engine results in wasted fuel and the decreased performance and life of the engine.

### SUMMARY OF THE INVENTION

A system and method for electronically managing the liquid propane gas (LPG) fumigation using a flow trim valve for motor vehicles allows a predetermined amount of liquid propane gas into the engine. The system and method uses electronic controls and a flow control valve to manage the amount of vaporized liquid propane that is sent to the engine and monitors the feedback conditions of the engine to vary the rate of vaporized liquid propane delivery.

In one aspect, the flow of supplemental fuel to a fuel stream received by an engine is regulated by sensing the operating characteristics of an engine. The system determines an operating window, which defines the optimum operating characteristics of the engine. A control map is stored in a memory storage device. The control map defines the percentage of fully open position for the trim valve. The system then determines whether the sensed operating characteristics are within the optimum operating characteristics defined by the operational window and varies the opening of the valve based upon whether the sensed operating characteristics are within the window and according to the control map.

In other aspects, the supplemental fuel rate to the engine is increased by altering the opening of the trim valve when the sensed operating characteristics remain within the operational window. When the operating characteristics are approaching a limit of the operational window, the rate is decreased. The operating characteristics are chosen from the group of system activation, engine revolutions per minute (RPM), manifold absolute pressure (NAP), and accelerator pedal position. Other characteristics may also be chosen.

Thus, the present system and method takes into account the operating conditions of the engine in deciding the amount of supplementary fuel to add. The system and method is advantageous because it prevents over-revving and over-boosting of the engine. Fuel is saved and engine performance is enhanced.

### BRIEF DESCRIPTION OF THE DRAWINGS

FIG. 1 is a block diagram in accordance with one embodiment of the invention;

FIG. 2 is a fuel grid in accordance with one embodiment of the invention.

FIG. 3 is a look-up table describing the operation of a fumigation system in accordance with one embodiment of the present invention;

FIG. 4 is a flowchart showing the operation of a fumigation system in accordance with one embodiment of the present invention; and

FIG. 5 is a chart showing the menu structure for entering calibration information in accordance with one embodiment of the present invention; and

FIGS. 6a-d are schematic diagrams showing one example of portions of a fumigation system in accordance with one embodiment of invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION OF THE PREFERRED EMBODIMENTS

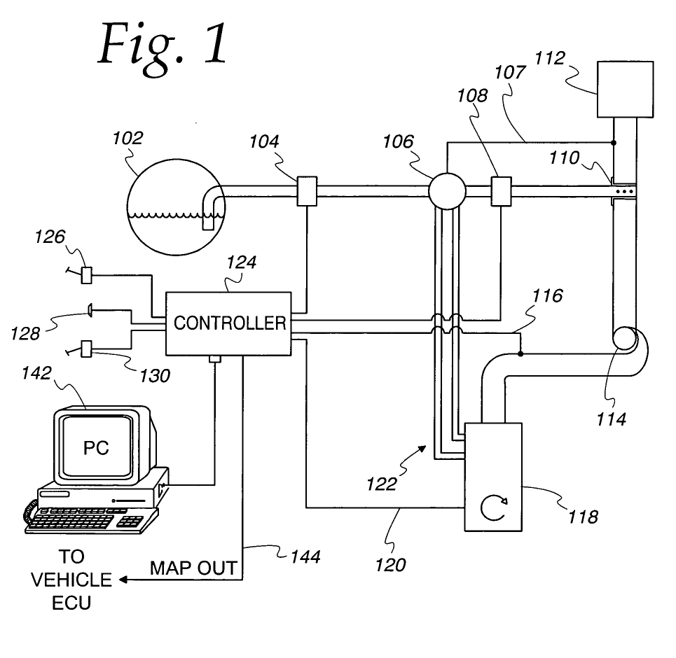

Referring now to FIG. 1, a system for electronically managing LPG fumigation includes an LPG propane fuel tank 102, a shutoff valve 104, a vaporizer regulator 106, a trim valve 108, a venturi mixer 110, an air filter 112, a turbo 114, a boost sensor 116, an engine 118, an RPM sensor 120, heater lines 122, controller 124, arm switch 126, check system light 128, and throttle pedal 130.

The system of FIG. 1 electronically controls the amount of LPG fuel used by an engine. The system uses feedback to sense the operating parameters of the engine 118 using, for example, the boost sensor 116 and the RPM sensor 120. As the fuel is added to the engine 118, the system monitors these parameters and determines whether the parameters are approaching the limits of an envelope of operation for the engine 118. If the determination is that the parameters are approaching the limits, then the fuel flow rate is reduced by using/controlling the trim valve 108. As the operating parameters indicate that the limits are exceeded, then the fuel flow rate is reduced to a minimum and then turned off by using/controlling the trim valve 108.

The LPG propane fuel tank 102 is used for storage of the LPG propane. In one example, the tank 102 may be under up to 312 psi of pressure. Flow of the fuel from the fuel tank is controlled by the shutoff valve 104, which halts the flow of propane unless the controller 124 requires that the valve 104 remain open. In one example, the valve 104 is 12 v switched with the engine. The controller 104 controls the ground connection to open the valve 104, which, in one example, is under 312 psi of pressure when closed (off).

The vaporizer regulator 106 vaporizes the liquid fuel flowing through the valve 104 into gas to flow into the engine 118. In one example, the pressure is up to 312 psi in, and 0 to −5 inches water out. A feedback line 107 is used to inform the vaporizer of an intake restriction, for instance, an air filter that is dirty.

The trim valve 108 controls the amount of flow of propane into the engine 118 via the fuel tank 102 and the vaporizer 106. The trim valve 108 includes a motor, a position sensor, and motor temperature sensor. The position sensor of the trim valve 108 tells the controller 124 the position of the trim valve 108, for example, the extent of the opening of the valve. The temperature sensor tells the controller 124 the temperature of the motor so that the motor can be protected from over heating.

The venturi mixer 110 generates a vacuum signal to pull propane into the engine. The feedback to regulator allows the vaporizer to know the intake restriction, for example, from a dirty air filter.

The air filter 112 cleans the engine intake air that will be used by the engine 118. A feedback line 107 allows the vaporizer regulator to know of an intake restriction, for instance, from a dirty air filter. The turbo 114 creates boost to put additional air into the engine.

The boost sensor (P) 116 measures the amount of boost and returns the information to the controller 124. The engine 118 includes the valves, and other parts of a diesel engine. The RPM sensor 120 measures the engine speed and returns the information to the controller 124. The heater lines 122 to the vaporizer provide heat to boil the liquid propane in the vaporizer.

The controller 124 monitors system status and control when and how much propane is put into the engine. As the fuel is added to the engine 118, the controller 124 monitors these parameters and determines whether the parameters have are approaching the limits of an envelope of operation for the engine 118. If the determination is that the parameters are approaching the limits, then the fuel flow rate is reduced using the trim valve 108. As the operating parameters indicate that the limits are exceeded, then the fuel flow rate is reduced to a minimum by the controller 124 and then turned off using the trim valve 108.

The controller 124 includes several switches, which help to control its operation. The arm switch (on/off) allows the driver to turn off the system so that no propane is put into the engine. The check system light 128 tells the driver when the system is not operating properly. A number of fault codes can be displayed by the check system light. The throttle pedal 130 is used to monitor the driver requested power. The controller 124 is coupled to PC and monitor 142. A MapOut output 144 is coupled to a vehicle controller (not shown). A MapIn signal 116 is coupled to the engine intake.

The fuel grid represents the percentage of fully open for the trim valve 108. Specifically, the fuel grid represents fuel flow versus pedal position and RPM of the engine. The trim valve 108 works in concert with the signal generator installed in the intake stream. As the engine air intake flow rate increases, a stronger signal is created in the vapor line pulling more propane into the engine. Thus, closing the trim valve 108 partially maintains the same amount of propane flow during times of stronger signal.

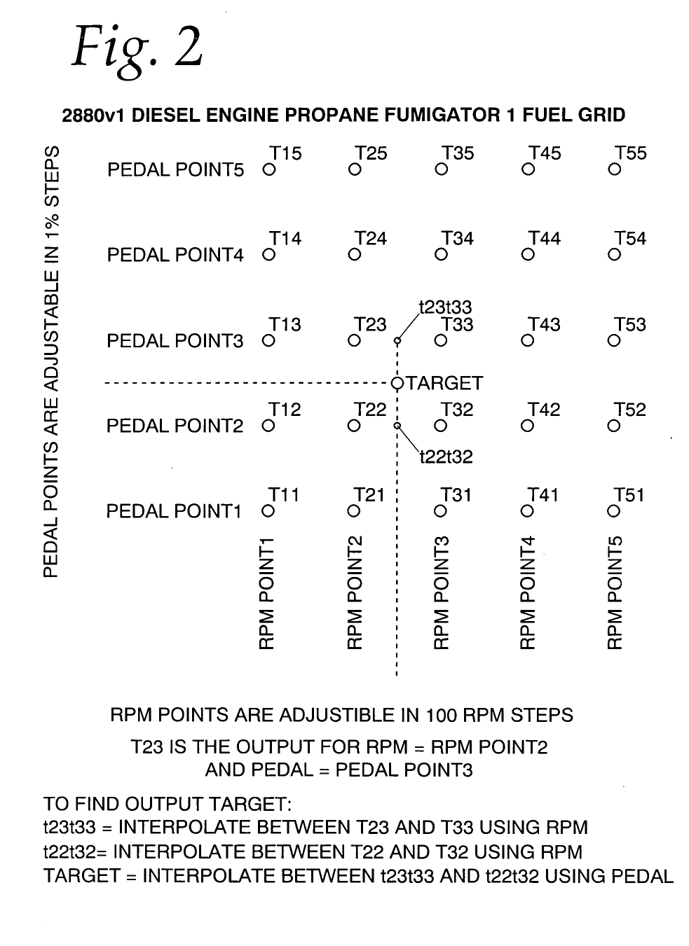

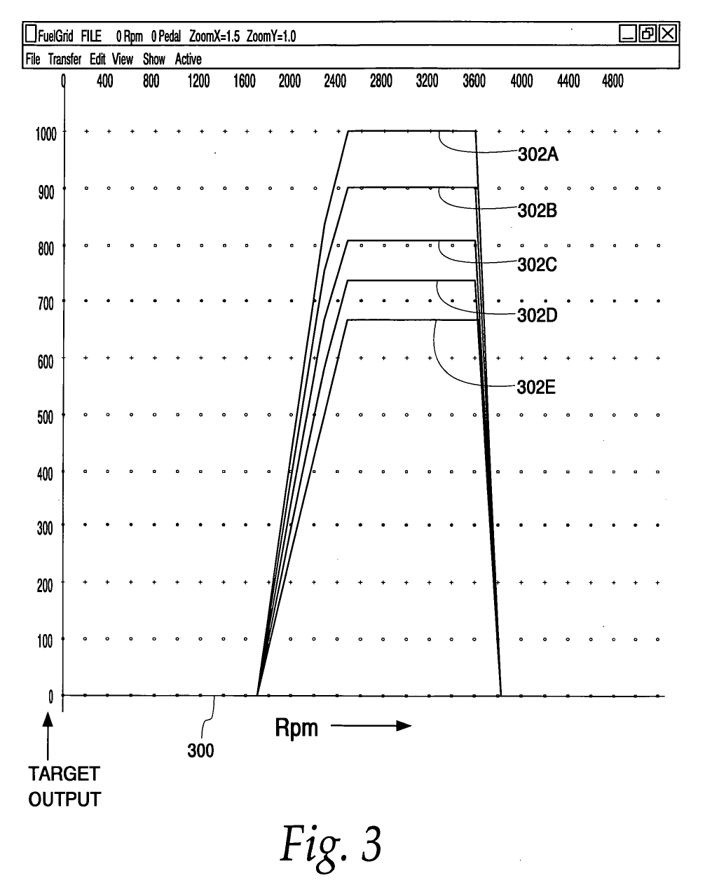

Referring now to FIG. 2, one example of the target matrix (fuel grid) stored by the controller 124 is described. The matrix 200 consists of a 5×5 matrix of points, each corresponding to a throttle pedal position and an engine RPM giving a target fuel trim valve position. Within the limits of this matrix are the only conditions in which fuel will flow. The scaling parameters and other safety limits may disallow fuel flow even when the target matrix may indicate opportunity. The fuel grid trim valve position target is interpolated within each cell for RPM and throttle position inputs as conditions change. A look-up table, for example, the one shown in FIG. 3, is then used to find the target fuel trim valve position.

In this example, each point on the matrix represents an RPM and pedal position. For instance, T23 represents the output pressure for an RPM of RPMPoint2 and pedal position of PedalPoint3. The inputs to the fuel grid are RPM and throttle position and the fuel target pressure is interpolated in steps. First, RPM is interpolated in two steps. Next, the pedal points are interpolated to find the target pedal position. Once these steps have been performed, a look-up table is used to find the correct target fuel trim valve position value.

In one example of the above-described procedure, to find the output target fuel trim valve position, point t23t33 is interpolated between points T23 and T33 using RPM. Then point t22t32 is interpolated between points T22 and T32 again using RPM. Then, the Target point is interpolated between t23t33 and t22t32 using pedal position. The Target value itself is found using a look-up table, for example, the look-up table of FIG. 3.

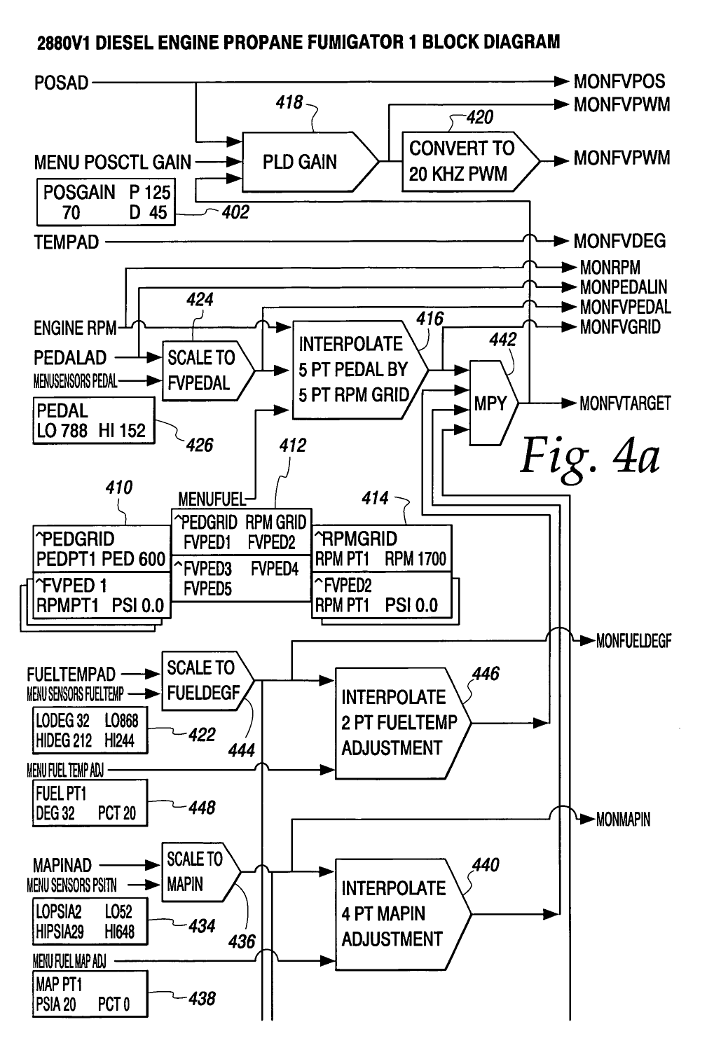

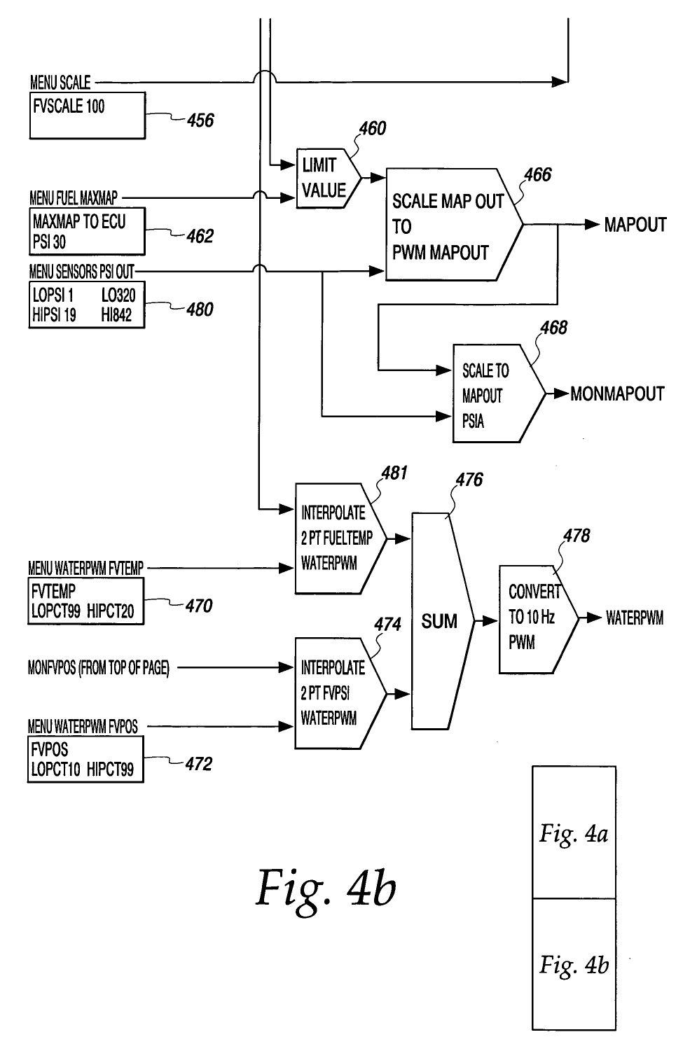

The values of FIG. 2 may be entered by a user using a menu. For example, this may be performed as described below with respect to steps 410 and 414 of FIG. 4. In this case, the user may input the values shown on the grid.

The fuel grid/matrix is one approach used for system protection, as points may be chosen such that no fuel is allowed to flow during unsafe or improper vehicle conditions. For example, the fuel flow may increase as engine speed increases, but then be reduced/shut off as engine speed continues to increase to help limit engine over speeding.

Sensors are employed by the system to determine the operating conditions of the vehicle and the fumigation system. The monitored vehicle functions include engine RPM, throttle pedal position, intake manifold pressure (boost), ambient pressure, engine water temperature and system request (on/off). The monitored system functions include fuel trim valve position, fuel temperature (at the trim valve) and fuel temperature at the manifold pressure sensor.

All sensors signals are returned to the controller as voltage values. These voltages are converted to a digital value and have a calibration value applied to them that is based on a two-point calibration curve. A known “high” condition and a known “low” condition are applied to the sensor, and the corresponding digital values stored in memory against this calibration. Subsequent voltages applied at this location are interpolated based on these points.

The scaling parameters are applied to the fuel grid pressures and are used to develop the target trim valve position at the vaporizer/regulator. The scaling parameters include manifold pressure, fuel temperature, engine water temperature and operator scaled input. The manifold pressure scalar is a four point curve with manifold pressure on the x-axis, and percent on the vertical y-axis.

In one example, 20 psia=0%, 22 psia=100%, 30 psia=100%, and 32 psia=0%. Fuel target is scaled to zero when manifold pressure is at 20 psia or below. As manifold pressure increases to 22 psia, fuel target correction is interpolated between 0 and 100%. Correction remains at 100% until the manifold pressure goes above 30 psia at which time the correction factor is interpolated down to zero as pressure continues to gain to 32 psia, at which time target value would be zero or no fuel.

Fuel temperature is corrected directly as a density change with temperature to a lower limit temperature where fuel is shut off to avoid passing unvaporized liquid propane through the regulator. Engine water temperature may be used as an upper limit value to reduce propane pressure when engine water temp climbs above a predetermined value, to reduce chance of engine overheating due to excessive power production. The operator scale is an input value the operator can access to reduce the overall LP gas input to the engine by a direct percentage.

The system also includes a cruise control mode of operation. In this mode, the system recognizes that engine speed is above a preset value (usually 1500 RPM) has changed less than 10% in the last 5 seconds, and the throttle pedal positions is near idle. Under these conditions, the system converts manifold pressure to a simulated throttle pedal position. Since the system would then see engine RPM, and the throttle pedal position to be within the window of operation for propane, it will enable propane based on the simulated throttle pedal position and RPM from the fuel grid and apply the regular scaling factors. As manifold pressure increases and decreases with load simulated throttle pedal position will increase and decrease, changing fueling as set in the fuel grid. If the system sees engine speed change more than 10% or an actual throttle pedal position appear, it reverts to normal operation. The system continuously monitors for stable conditions and will return to cruise when they are met. The cruise mode allows the propane system to engage on vehicles that use remote throttles such as pumpers and generators.

The scaling factors are used to allow tuning flexibility for the system to be applied to many different vehicles/systems. For example, manifold pressure and temperature may be used.

Safety protection for the engine system is also provided to minimize opportunity for operating in damaging conditions. The protection for the system includes engine over speed protection due to reduction of propane as engine speed exceeds boundary settings. Manifold over boost protection due to reduction of propane as manifold pressure exceeds boundary settings is also provided. Temperature protection of cooling system due to a reduction of fuel flow as engine heat output exceeds cooling system capability is additionally provided

Referring now to FIG. 3, an example of a look-up table 300 as used by controller is described. The look-up table includes five plots 302a-e, which represent a fixed pedal reference position. The pedal references 302a-e may be set via an operator as a percentage of pedal position. Each of the references 302a-e is graphed versus engine RPM (horizontal axis) and gives a percentage open value for the trim valve. Within the limits of this matrix are the conditions defining the fuel target pressure to the engine.

Once obtained from the table, the valve position is scaled. The controller 124 takes the scaled target valve position and controls the position of the control valve to allow fuel to flow at the target position to the manifold. The position of the trim valve allows the signal generator in the manifold to flow fuel in proportion to the trim valve opening. The position of the fuel trim valve position is monitored and compared to the fuel trim valve target position and adjusted to the target position value to lower or raise the supplied fuel to the manifold.

The fuel trim valve position is calculated by interpolating between two fixed pedal lines at the measured engine RPM. Once obtained from the table, the position is scaled. The controller takes the scaled target position and drives the trim valve to open or close to the target position causing fuel to flow. The trim valve is operated by a limited angle torque motor driven by a transistor full bridge circuit in the controller. As the engine air intake flow rate increases, a stronger signal is created in the signal generator 110 pulling more propane into the engine. Alternatively, a gear motor actuated trim valve could be driven by the controller 124.

In this example of the use of the look-up table, the target trim valve position varies between 0 to 100%, or closed to full open. Engine RPM varies between 0 and 5000 RPM. The pedal may be in one of five positions (302a-e). If grid position calls for 20% at 3200 and 22% at 3400 RPM, then it can be interpolated that at 3300 RPM, the target position is 21% open.

Referring now to FIG. 4, an example of an approach for obtaining a target fuel trim valve position is described. The approach may be implemented via computer software that is stored in the controller of the system. The position PID loop values related to position control are received at step 402. Where known values are programmed, for instance, from input of an operator, whom programs these factors into the system.

The menu items received at steps 410, 412, 414, 426, 434, 438, 442, 448, 456, 480, 462, 470 and 472 in FIG. 4 are user input values. For each of these items, a field may be displayed as a menu box on the screen of a personal computer for a value to be input by the user. The values received may be analog values input to an analog-to-digital converter for the voltage sent into the controller by the sensor or control signal. The menu box contains the values of the two-point calibration curve for that sensor. These inputs are used to convert the sensor signals from machine units (e.g., millivolts) to correctly scaled human units (e.g., psi, degrees Fahrenheit).

At steps 410, 412 and 414 calibration values relating to the fuel grid (Menu Fuel), RPM grid (Menu RPM Grid), and pedal grid (Menu Ped Grid) are received. These parameters represent the value of the points that have been entered on the main window of the program to determine how much fuel pressure to deliver, at what RPM, and at what pedal position. In other words, the values received in the above-mentioned steps represent the main fuel grid.

At step 426, calibration values (Menu Sensors Pedal) relating to the pedal position (Menu Sensors Pedal) are displayed and programmed. These user input values used by the system to set the two point digital calibration of the voltage sent to the controller accelerator pedal position sensor.

At step 434, calibration values relating to manifold pressure (Menu Sensors Map In) are displayed and programmed. At step 438, calibration values representing fuel mapping adjustment (Menu Fuel Map Adj) are displayed and programmed. These values are used to scale back the amount of propane as a function of manifold pressure until the manifold pressure reaches the maximum MAP value point. At step 422, calibration values relating to sensed fuel temperature (Menu Sensors Fuel Temp) are displayed and programmed. These values are used to set the two-point digital calibration of the voltage sent to the controller by the temperature sensor that is part of the manifold pressure sensor. At step 448, calibration values relating to fuel temperature adjustment (Menu Fuel Temp Adj) are displayed and programmed. These values represent the correction factor to be applied to the target fuel trim valve position to adjust for density changes due to temperature. This scale is based on the natural expansion of the gas as it gets hotter starting from zero pressure at the temperature of absolute zero.

At step 462, calibration values relating to fuel max MAP (Menu Fuel Max Map) are displayed and programmed. The controller has the ability to simulate the manifold absolute pressure signal that is sent to the standard vehicle controller. The simulated value will represent exactly the actual manifold pressure up to the user input value. As manifold pressure increases beyond this number, the controller sends a signal to the vehicle controller of this user value. At step 480, PSI Out is displayed and programmed.

At steps 470 and 472, calibration values relating to the temperature of the regulator (Menu Water Pwm Fv Temp and Menu Water Pwm Fv Pos) are displayed and programmed. These values are the user input values used to set the tvo-point calibration of the water temperature control that may be used to control the temperature of the body of the fuel pressure regulator/vaporizer.

The calibration values discussed above are used to scale the values of various received inputs. For example, at step 436, the manifold pressure value is scaled. At step 444, the fuel temperature is scaled. At step 470, the water temperature of engine is scaled.

At step 460, the manifold pressure value is limited. The simulated value determined represents exactly the actual manifold pressure up to the user input value. As manifold pressure increases beyond this number, the controller sends a signal to the vehicle ECU of this user value scaled in step 466.

At step 440, a manifold pressure adjustment is calculated. The value of the adjustment is calculated with respect to a control value, as the control value changes, based upon the relationship of the target point to the control value at two known locations.

At step 446, a fuel temperature adjustment is calculated. This adjustment is used to correct the target trim valve position at step 442.

At step 416, scaling parameters are applied to the fuel grid position as the target position at the trim valve is determined. The value of the target point is calculated with respect to a control value, as the control value changes, based upon the relationship of the target point to the control value at two known locations. This determines the target position as the RPM and the throttle pedal movement between the exact set point on the fuel grid. Further, at step 442, the scaling parameters relating to the manifold pressure, the fuel temperature, the engine water temperature and the operator input indicating whether the system is activated or deactivated are multiplied to obtain a composite/corrected target value. The value obtained using the fuel grid is used along with the other parameters to determine the target position to be applied to the trim valve.

At step 418, proportional and integrated gains are calculated. The system takes the value obtained by a user entering a PosCtl Gain at step 402, develops the Fuel Valve Pulse Width Modulation (FVPwm) value, which indicates the control current magnitude and direction to drive the trim valve torque motor to position the trim valve in response to the need to supply fuel in the system.

The output FV Pos is a feedback loop and tells the controller what position the trim valve is to verify that it matches the requested position. At step 420, the developed FVPwm value is received and converted to a full bridge motor drive output with a duty cycle representing the direction of rotation to open or close the trim valve.

At step 466 and 468, the manifold pressure is scaled to provide a manifold pressure output. At step 470 and 474, the fuel temperature and fuel trim valve position control are interpolated. These values are summed at step 476 and converted into a 10 hz waveform at step 478. At step 481, the fuel temperature is interpolated.

In addition, various values may be monitored and displayed on a monitor screen. For example, the system may be coupled to a handheld monitor or laptop computer. RPM, FvGrid, FvPedal, FvDegF, FuelDegF, Idle Psi, Pwm, FVPos, FV Grid, FV Target, PedalIn, FV Pedal, PsiaIn, Water PWM, and PsiaOut, MaxFvPos, SagFvPos, 2FvPos, 2Pedal, 2FvDegF, FuelSw, FuelRelay are monitored. One example of a communication interface is described in U.S. Pat. No. 6,304,814 which is incorporated herein by reference in its entirety.

Map Out is an output value that is generated and can be sent to a vehicle ECU in place of the actual Map (Manifold Absolute Pressure) value generated by the original vehicle sensor. This may be used to manipulate the vehicle ECU by limiting how high a manifold pressure signal it receives. This would allow the engine system to operate in a manifold pressure region where the vehicle ECU may normally take steps to avoid (because the vehicle ECU doesn't know the engine system has gone there). The MAP out value from the propane system ECU accurately tracks manifold pressure until a value set in the software (Max Map to ECU) is reached, and then that value is held to that ceiling until manifold pressure drops below, then the propane system returns to sending accurate values.

The variable Water PWM value is a Pulse Width Modulated voltage signal that may be used to control a solenoid that can be installed in the heater lines to the vaporizer/regulator assembly. Controlling the flow of the very hot water through the regulator assembly may keep the regulator from reaching high temperatures, at which deposits may be formed in the regulator from elements dropping out of the propane as it passes through the hot environment.

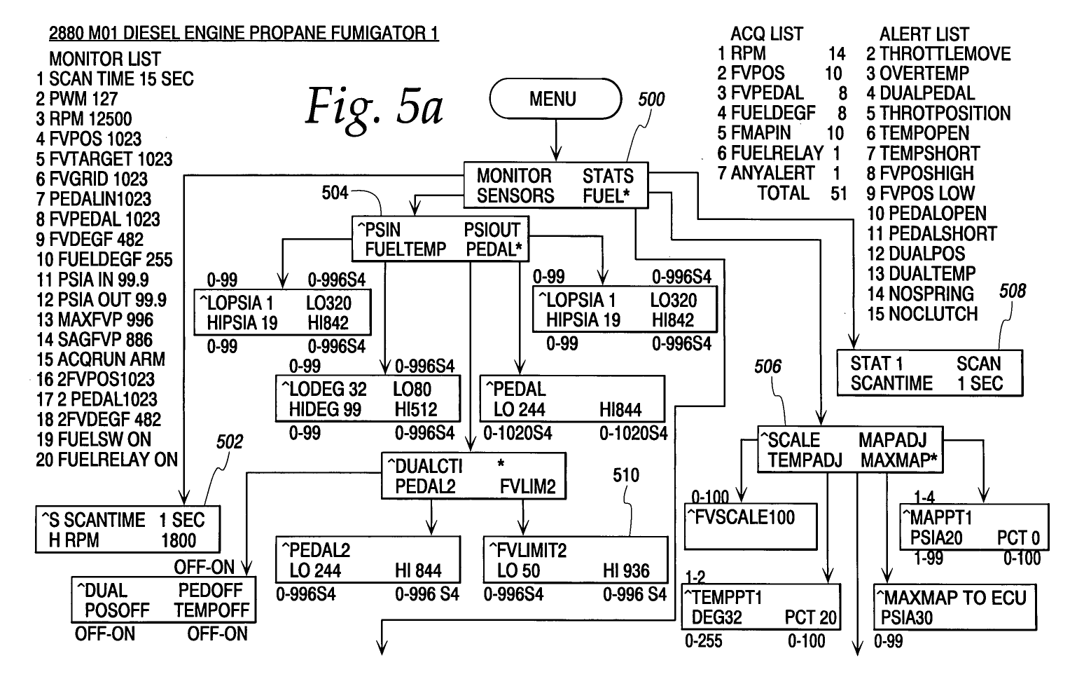

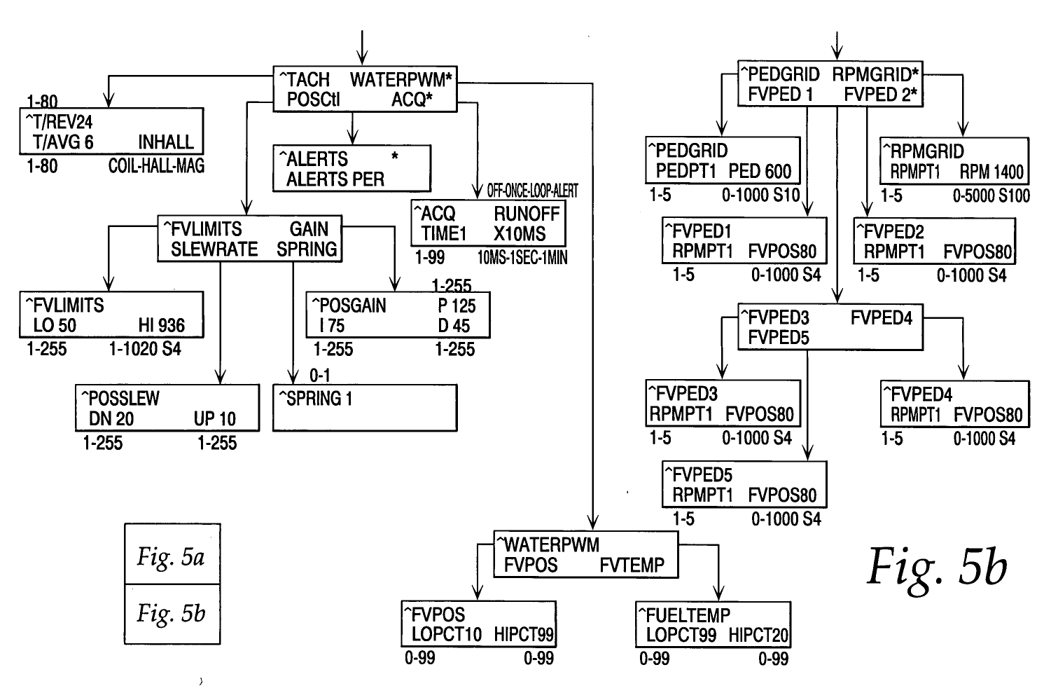

Referring now to FIG. 5, an example of a menu tree used to program the calibration parameters used by the system is described. The menu tree represents various displays that can be made available to an operator on a personal computer display. One example of a user interface is described in U.S. Pat. No. 6,304,814, which has been incorporated herein by reference in its entirety. By using these screens, the user can make selections and move to other screens. In other screens, the user chooses calibration ranges for use by the ECU as described above.

One example of the use of the menu tree is now described. The menu tree is entered at step 500. At that step, the user can make a selection of a parameter type, including monitor, stats, sensors, and fuel or go to the next main menu to select Tach, WaterPWM, PosCtL or Acq.

After making the selection, the menu progresses at steps 502 or 504, where further choices are made. For example, at step 504, the user can select PsiIn, PsiOut, FuelTemp, and Pedal. Each box represents up to four values. The maximum corresponding digital range is shown. For example, box 510 has a FvImit2 Low value of 50 of 1 with a corresponding digital range of 0 to 996.

As can be seen selection is continued until a leaf on the tree is reached. At that point, the user programs in the calibration factors. For instance, if programming reaches step 504, the user programs in high and low Psi values and the corresponding scaled values. Similar choices can be made at all the other leaves of the tree and will not be described here. It will also be apparent to those skilled in the art that the particular menu structure employed and the exact corresponding calibration values may be varied by an operator.

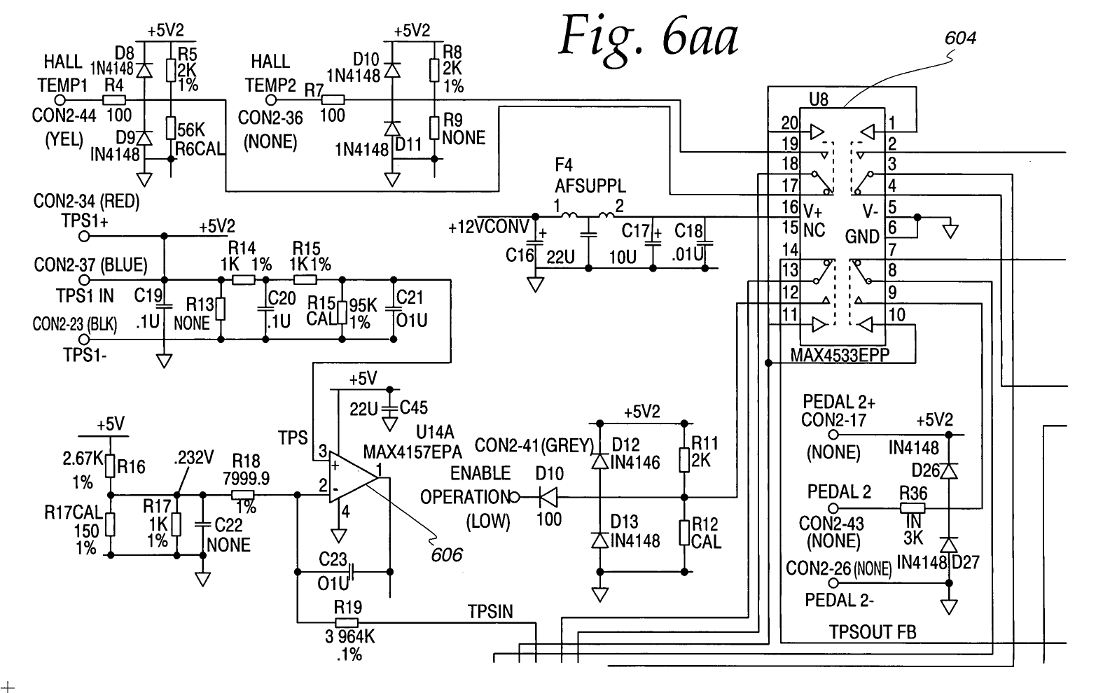

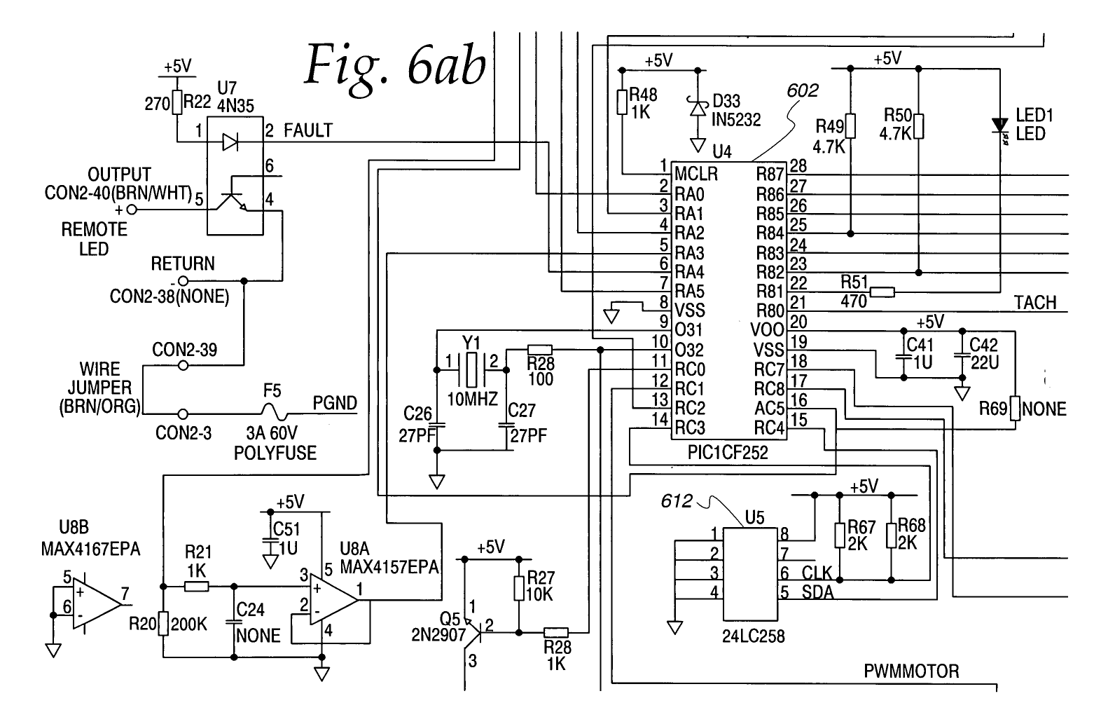

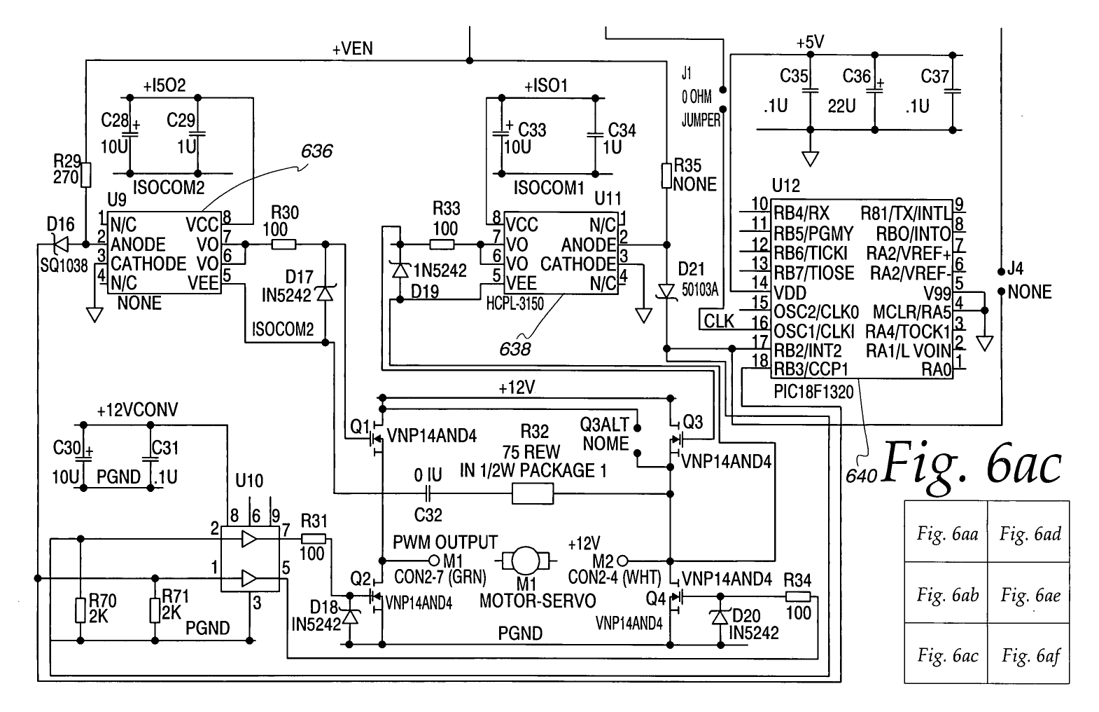

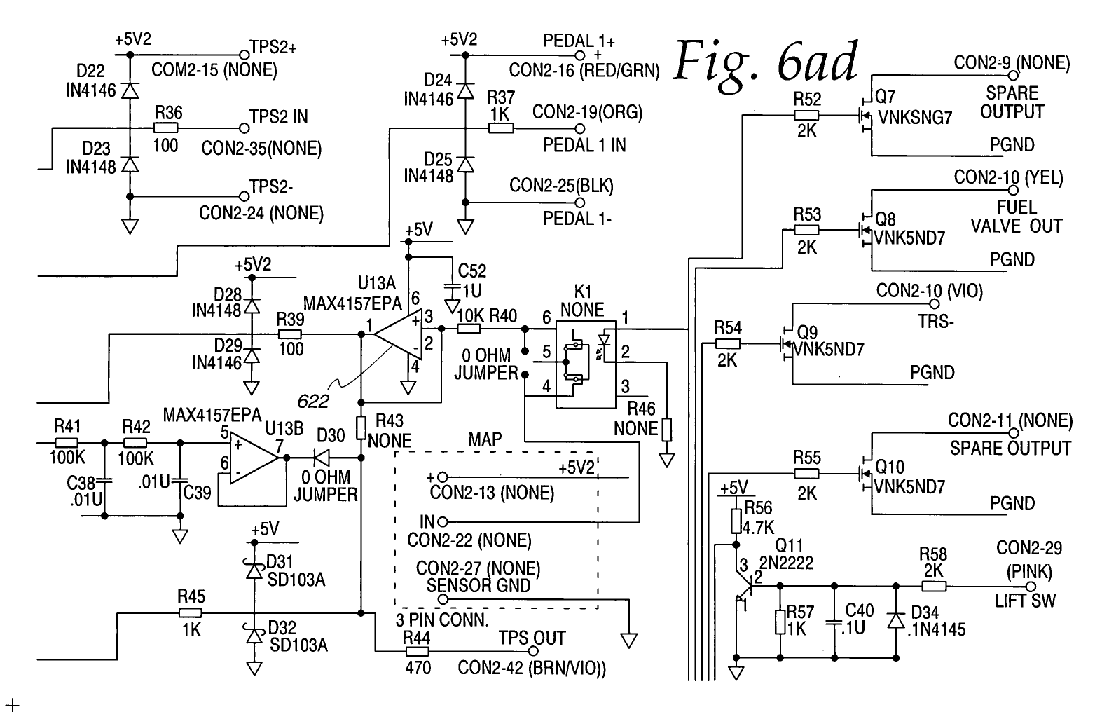

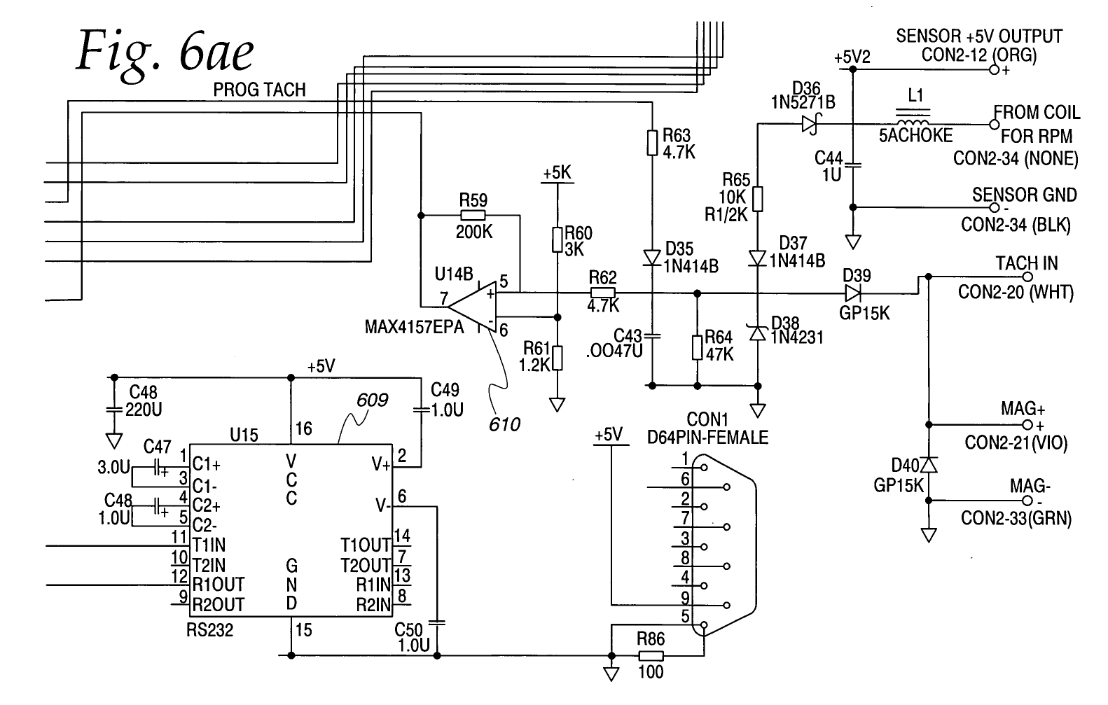

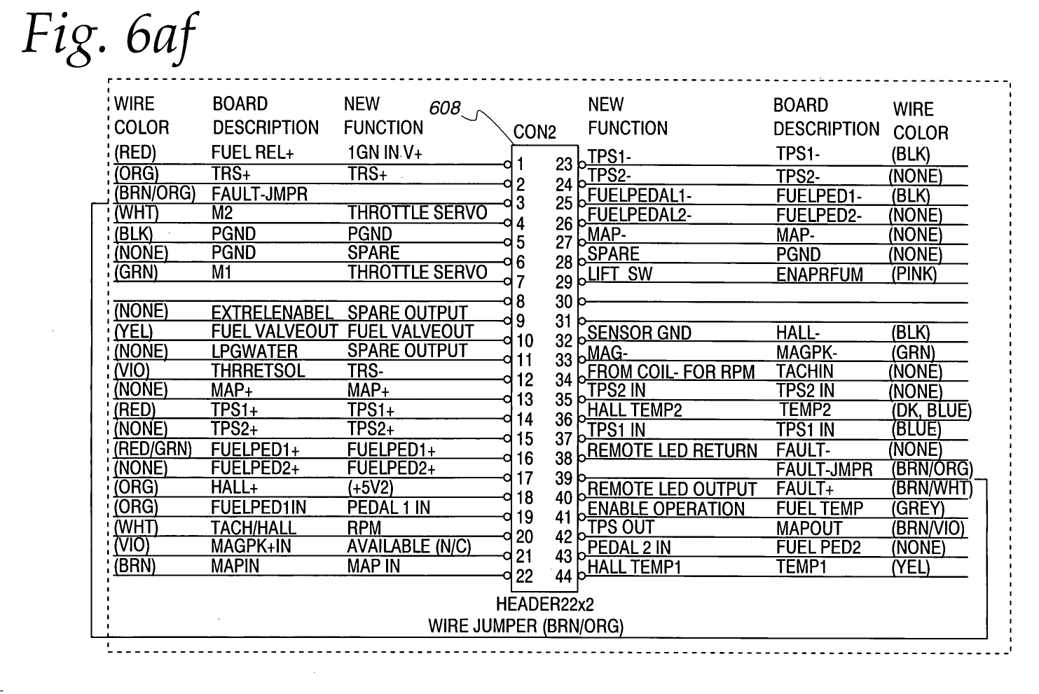

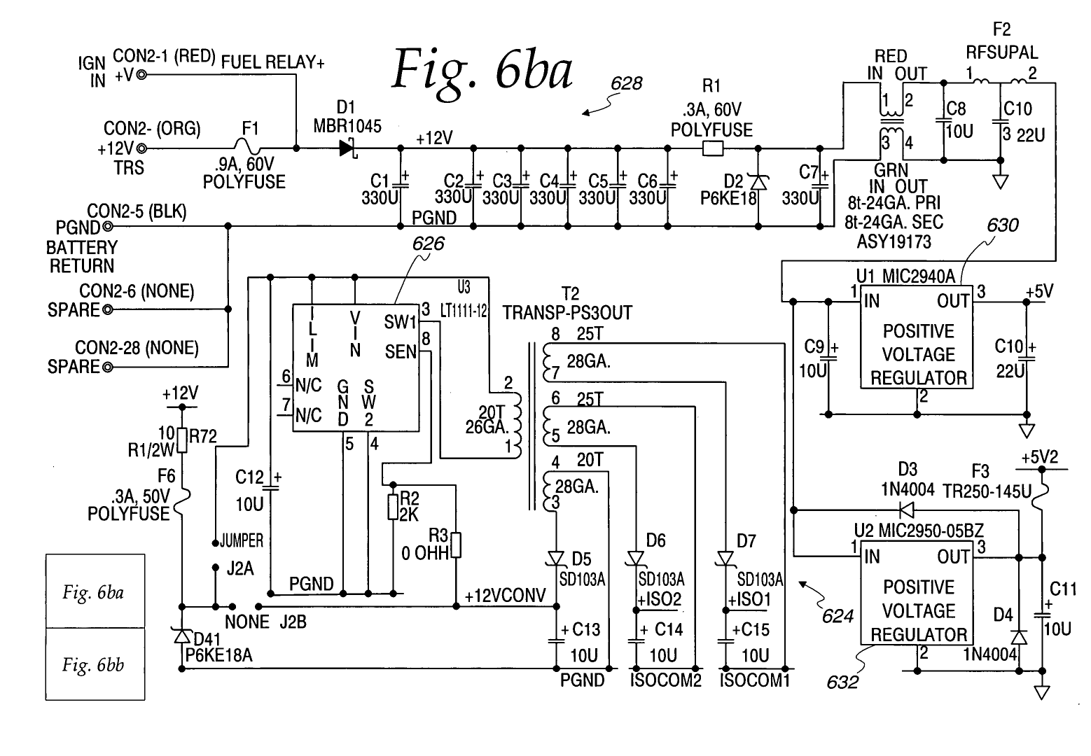

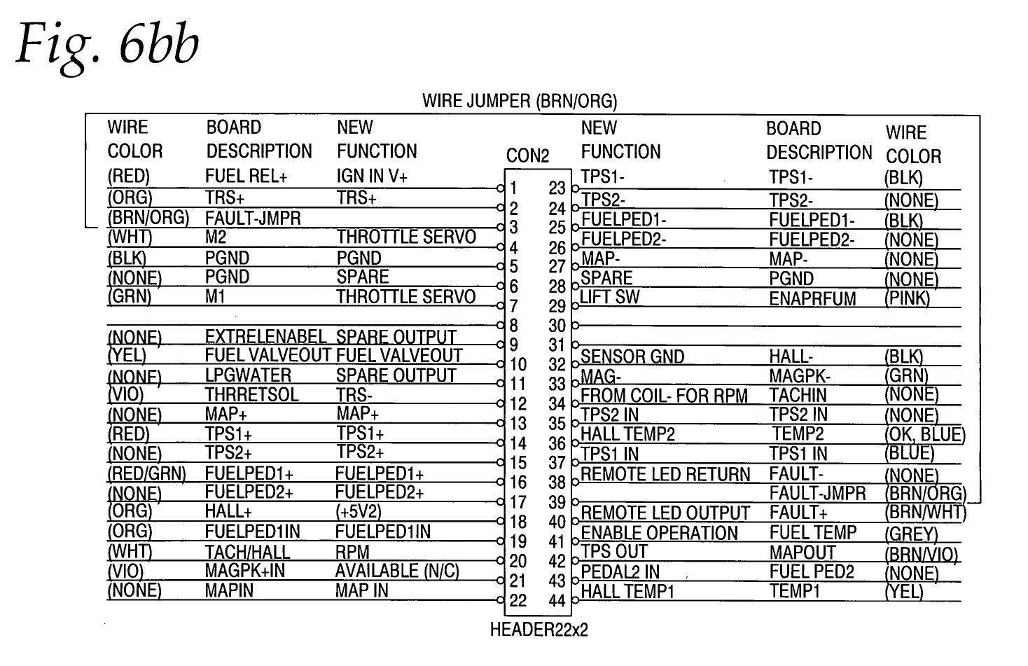

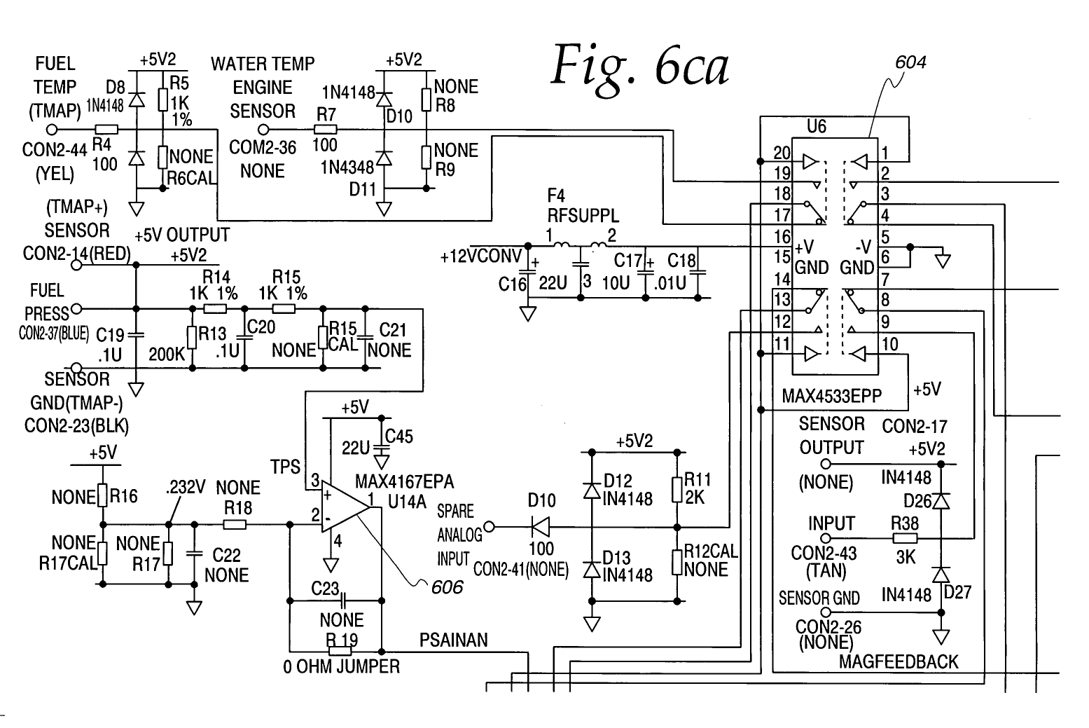

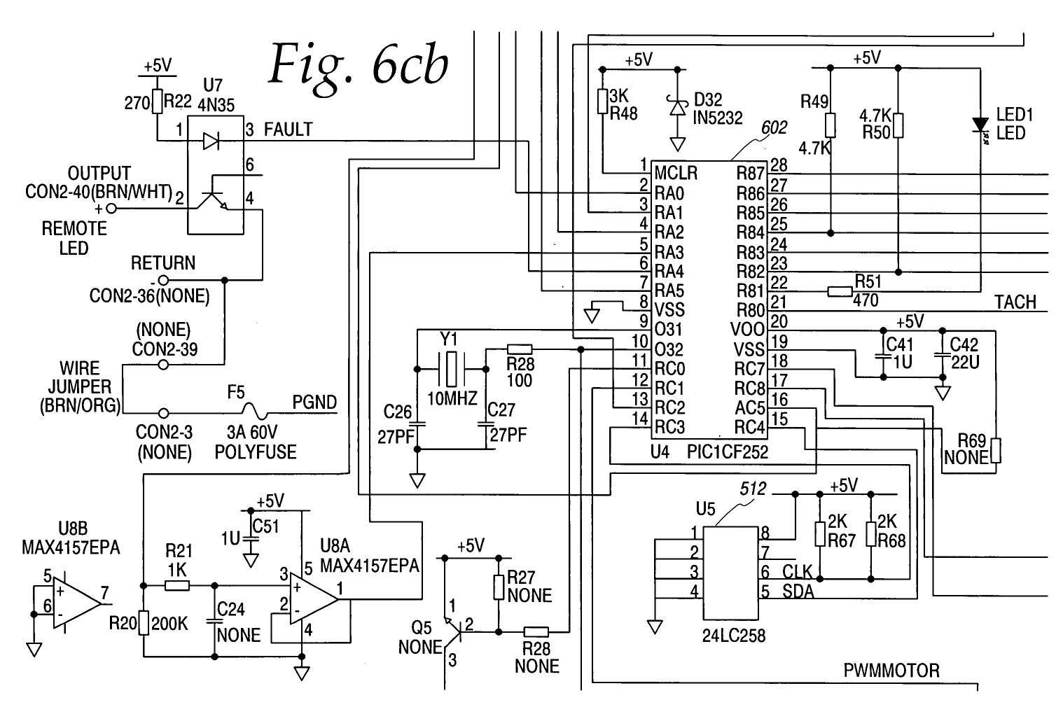

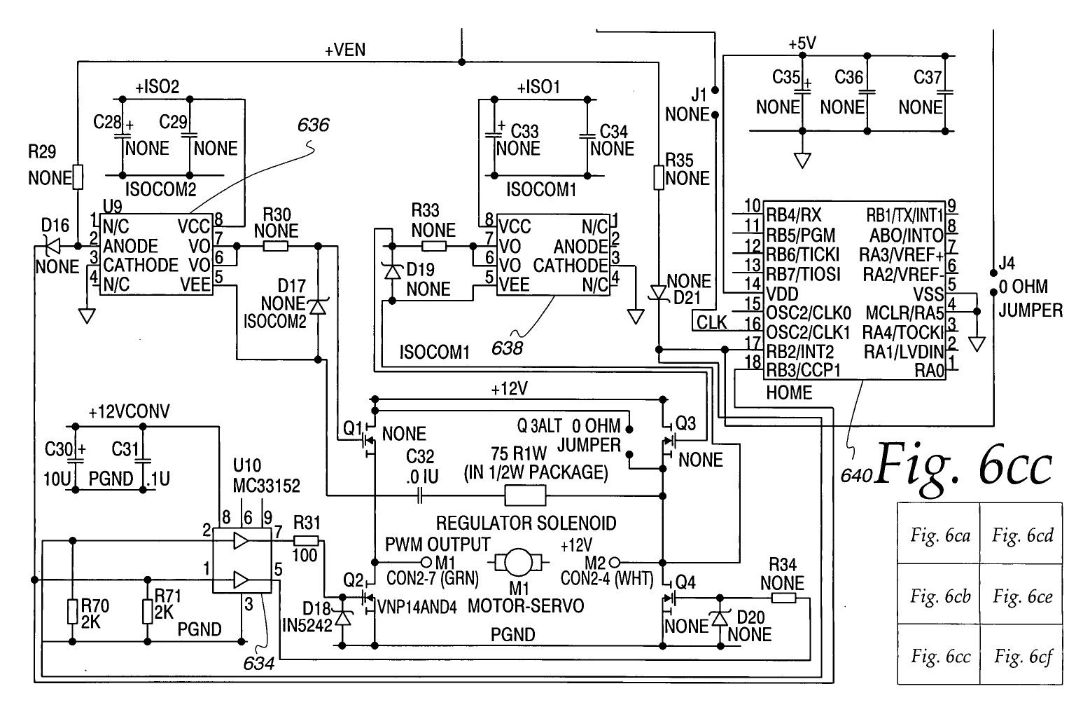

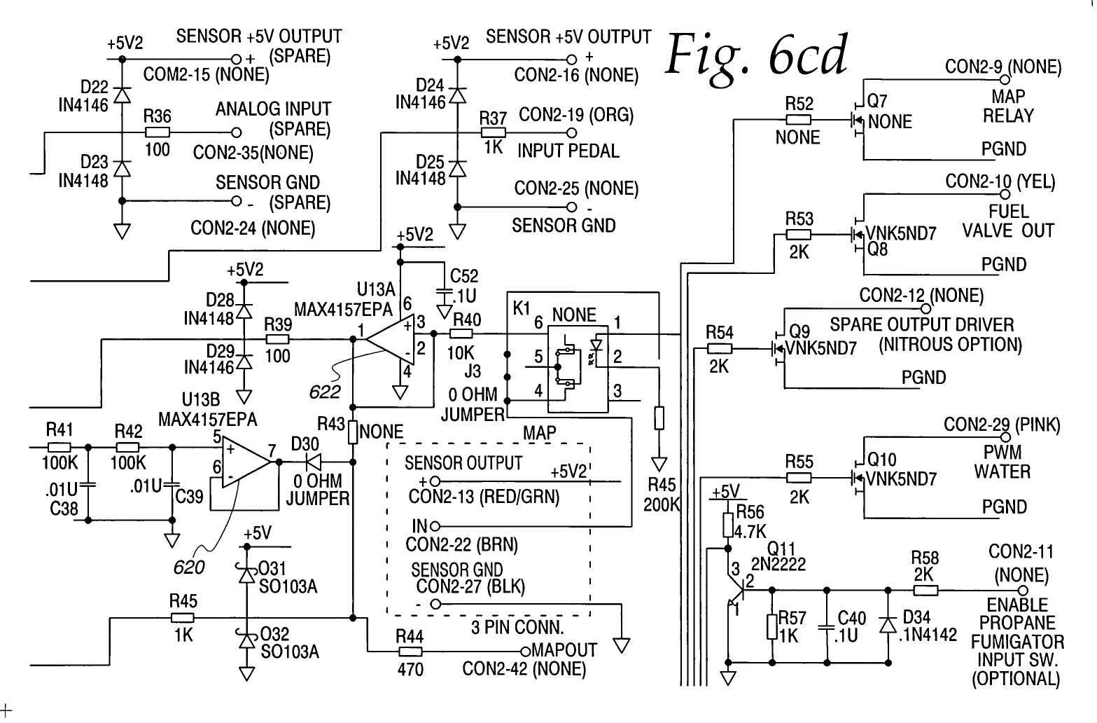

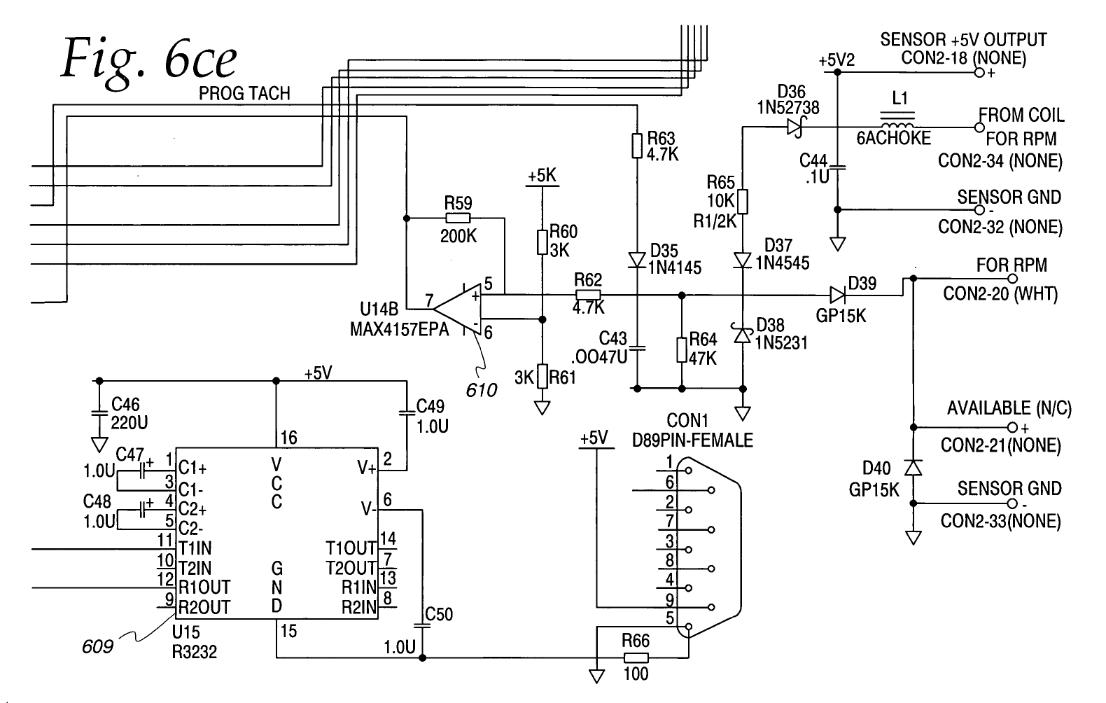

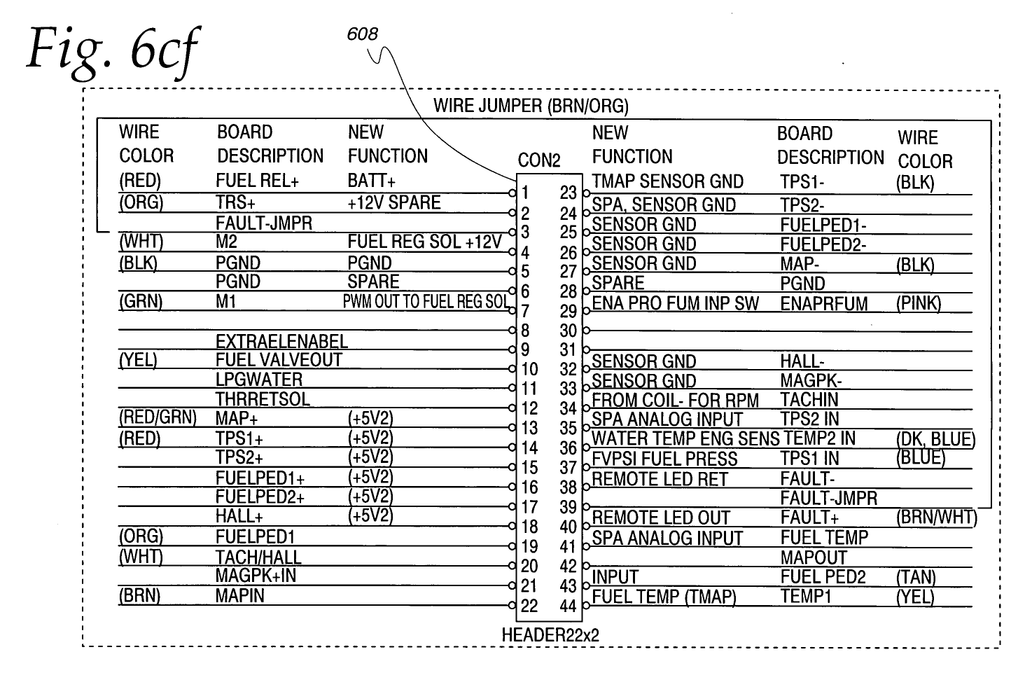

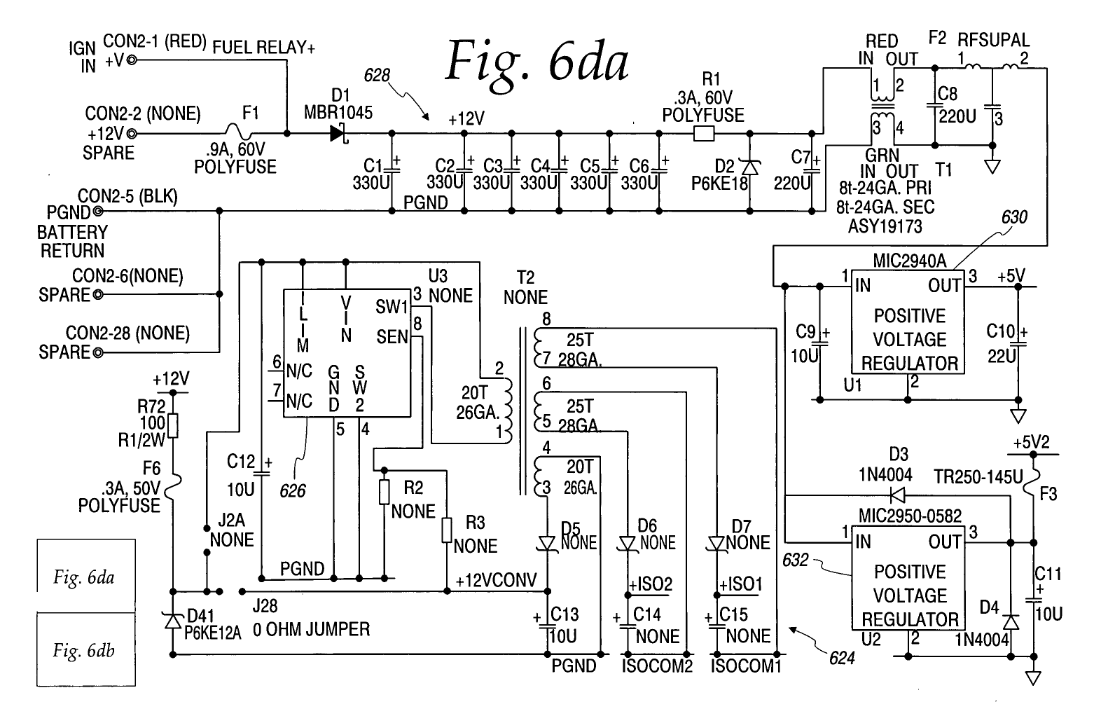

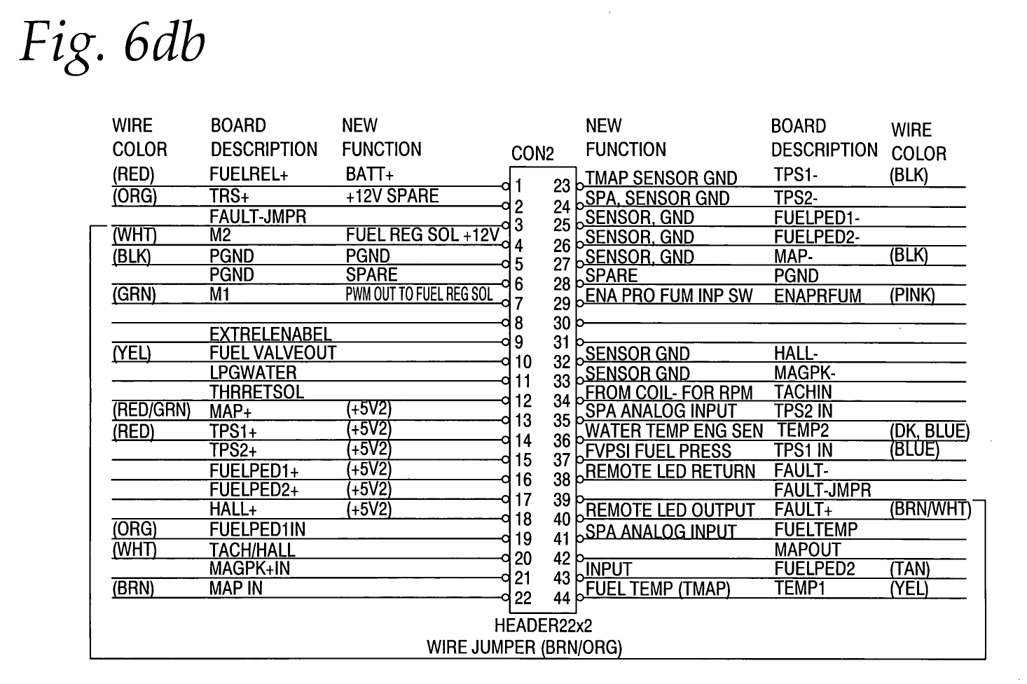

Referring now to FIGS. 6a-d, one example of a fumigation controller is described. The controller may control servomotors that are used for fly-by-wire engine throttle devices to control the trim valve position (FIG. 6a-b). Alternatively, the controller may be a programmable servo controller designed for controlling valves in the propane fumigation system (FIG. 6c-d). Other applications are possible. It will be realized by those skilled in the art that various changes and/or modifications may be made to the controller described herein to adapt it to various applications or to optinize performance. Since both examples share many components, they will be discussed together.

A flash microcontroller 602, which is a RISC type architecture made by Micro Chip, and, in one example, is a PIC18F252 is used for various control functions. The microcontroller 602 is operated with an internal 40 MHz clock speed to give 10 MIPS typical operation speed. The microcontroller 602 contains five, 10-bit analog to digital converters that are multiplexed with a 4 pole, 2-position IC analog switch 604, for instance, a switch having part number MAX4533EPP, which is manufactured by Maxim Semiconductor. The analog multiplexer 604 expands the five analog inputs to nine analog inputs to allow all of the sensor data to be measured by the microcontroller 602 at A/D input pins RA0, RA1, RA2, RA3, and RA5. The analog sensor data is input either directly to the microcontroller analog-to-digital (A/D) input or through the multiplexer 604, in order of importance. The primary A/D input is found on input RA0, which is the most frequently scanned analog input, which is from the trim valve position sensor conditioned by amplifier 606 for feedback closed loop control of the trim valve position.

The multiplexer 604 shares eight inputs to the remaining four A/D microcontroller inputs. The two highest priority analog signals are the propane trim valve position and the manifold pressure, which is used to determine the fuel pressure to deliver to the engine. These two inputs, fuel pressure and manifold pressure, are both converted to a digital value at a rate of 2500 times/second and are both averaged over 6 milliseconds for the value used for calculating the fuel delivery. The next set of analog inputs are secondary in priority and are converted at a rate of 1250 times/second, and averaged over 13 milliseconds, are MapOut, FuelPedal1, and FuelTemp, coming from the multiplexer 604. The last group of analog data are of less priority and are converted at a rate of 625 times/second and averaged over 26 milliseconds are FuelPedal2, WaterTemp, and FvTemp.

In this example, the trim valve position is being controlled. The fuel and manifold pressures are converted by the microcontroller 602 A/D inputs at a relatively high rate to maintain good close loop servo control of the fuel vs. manifold pressure. The input of the trim valve position signal is connected to the controller at pin 37 of a connector 608. The connector 608 may be any suitable electrical connector as is known in the art.

The trim valve position signal is conditioned by op-amp 606 and the output of op-amp 606 is connected to the RA0 A/D input of controller 602 at pin 2. The input op-amp 606 is configured in this embodiment as an amplifier with offset and gain when used for the trim valve position sensor input. Slower conversion rates of these two sensors would cause delays that would cause instability resulting in overshoot, undershoot, and ringing or hunting of the propane delivery around the calculated fuel delivery target. This method is very effective in controlling the propane fuel delivery with good transient response and good steady state closed loop control of the propane delivered maintaining the target value calculated by the microcontroller. The secondary inputs are not required as often to keep the servo loop at the target value but are needed less often to allow fuel target selections and adjustments of the fuel target value. Fuel temperature and MapOut are not as often converted as these inputs are used to adjust the fuel target value and have a less critical part in the closed loop operation of the fuel delivery.

The FuelPedal1 input is the user commanded input to inform the controller that the fuel pedal position is to allow supplemental propane fuel to be delivered when above the idle position and above a minimum fuel pedal position to select fuel target value. FuelPedal2 is even less often converted as it is used for comparison to the FuelPedal1 position for redundancy to check that the FuelPedal signals are relative to one another for fault shut down in the event of a fuel pedal open, short or faulty operation in the fuel pedal circuit. The water temperature sensor is one of the low priority analog inputs that are used to adjust the fuel target value but since the water temperature has a long delta, this data can be updated at a much slower rate than other analog data. The controller, via the multiplexer 604, measures the MapOut signal used for the monitor display and fault detection of this output voltage from the controller to the vehicle ECU.

The other inputs to the microcontroller 602 are Tach or RPM at pin 20 of the connector 608, Coil-RPM at pin 34 of the connector 608, and Enable Propane Fumigation Input at pin 29 of the connector 608. In this example, these are digital inputs. The RPM signal can come from three sources, a tachometer input signal in the form of a 0-5 volt or 0-12 volt signal at the input pin 20 of the connector 608 that is debounced and converted to a 0-5 volt signal connected to the microcontroller interrupt input, RB0, which the microcontroller interrupts on the edge of this signal to measure the engine speed. The RPM signal can also be supplied by a magnetic pickup signal connected to pins 21 of the connector 608 and 33. The magpickup signal is clamped to negative 0.7 volts by diode D40 and clamped to positive +5 volts by zener diode D3, protecting the voltage comparator input at operational amplifier 610 pin 5. The third RPM signal input can be from an ignition coil primary signal that is connected to pin 34 of the connector 608 to the ignition coil primary C-terminal. The high voltage inductive voltage spike at this input is lowered by the series zener diode D36 and current limited by the 10 K ohm resistor R65 to develop a voltage at input of pin 5 of comparator 610. The voltage comparator 610 can be programmed by the microcontroller for a pull up at the input at pin5 via R63 and D35 connected to pin 26 of microcontroller 602, a microcontroller output pin. The user can select from the program menu what type of input RPM signal is to be used for the microcontroller 602 to select pulling up pin 5 or not of the voltage comparator 610. When the user selects Hall input, the output of microcontroller 602 is high at pin 26 providing a pull-up bias at pin 5 of comparator 610, which is then pulled down by the external Hall effect speed sensor or other digital input signal that can sink the small bias current supplied by the combination of resistor R63 and the diode D35 to the voltage comparator. Diode D39 blocks any input positive input voltages present at the pin 20 of connector 608 input pin. Also, diode D40 clamps any negative voltage at pin 20 of connector 608 as well.

When the user selects MagInput in the program menu for the Tach input signal, the pull up bias is also selected for the comparator input. When the user selects Coil tach input the pull up bias is turned off and not supplied to the comparator input. The Coil input provides bias to the comparator input when the coil terminal voltage rises high enough to reverse bias Zener diode D36, about 100 volts positive. When pin 5 input of the comparator 610 rises above the reference voltage at the inverting input at pin 6 of comparator 610, then the comparator output at pin 7 goes high to +5 volts, and pin 7 is connected to the microcontroller 602 at pin 21 to provide the tach-input signal. In this example, the resistor R59 is a 200 K-ohm resistor provides positive feedback or hysteresis for comparator 610 to keep the output stable at low input slow rise and falling signals. This RPM input circuit uses circuitry to allow a wide range and type of input signals using a single voltage comparator that can be user/menu selected for the specific type of input signal connected to the controller.

The input labeled “Enable Propane Fumigator” is used to enable the propane fumigation system to supply propane to the engine when the fuel target has been set, if this input is at +12 volts input. This input is buffered by transistor Q11, to set the input at pin 24 of controller 602 low when enabled to operate. The output fuel valve will remain closed if this input is not enabled to prevent fuel from exiting the propane tank, via fuel valve output at pin 10 of connector 608.

The microcontroller 602 is connected to EEPROM 612, or electrically erasable programmable read only memory device, a 24LC256 device from Micro Chip that allows 256-killobits of serial data to be stored. It is connected to the microcontroller over two control lines, a clock and serial data input/output line. Pin 6 of memory device 612 is the CLK or clock input of the EEPROM and is connected to the microcontroller pin 14 that supplies the clock output. Pin 5 of EEPROM 612 is the SDA or data I/O pin connected to the microcontroller I/O pin 15. The user menu and operating parameters are stored in the EEPROM 612 and are loaded into the microcontroller RAM registers at power on. The user interface is described in U.S. Pat. No. 6,304,814, which has been incorporated herein by reference in its entirety, and is used in the programming of this controller via a handheld programmer or PC. The EEPROM 612 also provides data storage for a data acquisition mode of the controller. The amount of memory used by the EEPROM 612 for data acquisition is, in one example, 16 Kbytes and the EEPROM 612 may store from 20 seconds at 10 ms per sample to 8000 minutes at 4 minutes per sample of data. The data stored is all of the input sensor and output control parameters; see the menu chart, Acq List for the list of monitor items that are stored. In addition faults are stored in a fault log, which, in one example, holds the last 10 faults in operation as they have occurred. The faults are rotated down the fault list, as new faults are stored in the fault log.

The microcontroller 602 communicates over a standard RS232C serial cable connected to the DB-9 pin connector to the handheld programmer or any PC running Windows operating system. The RS232 IC 609 is connected to the UART com-Port of the microcontroller 602 at pins 18 and 17. The serial communications operates at 9600 baud for the programming and monitor transfers, but switches to 115 Kbaud when transferring the data acquisition from EEPROM 612 to the PC.

The outputs of the microcontroller 602 control the fuel shutoff valve at pin 10 of the connector 608, the Map relay at pin 9 of connector 608 (if used), PWM water valve at pin 11 of connector 608, trim valve clutch solenoid (TRS-) at pin 12 of connector 608, the Fuel PWM valve at pins 7 and 4 of the connector 608. Also outputs for remote monitoring are available at pins 40,39, and 3 for remote LED drive or isolated interface of controller status, Map output at pin 42 of connector 608, that can provide and adjusted/limited Map output signal to the vehicle ECU.

The microcontroller 602 has two PWM outputs, one at pin 13 and the other at pin 12. The PWM output at pin 13 is used to provide a pulse stream to the filter network of R41, C38, R42, C39, that filters to provide a voltage at the input of the buffer amplifier pin 5 of operational amplifier 620, which is a unity gain operational amplifier. The frequency of the PWM at this pin is of at least 15 kHz for quick response while allowing small RC time constants in the filter network and results in very low output voltage ripple. The output voltage at pin 7 of the operational amplifier 620 is connected to a jumper or diode at D30 which will provide a simulated MAP output voltage at pin 42 of connector 608 via current limiting resistor R44. The Map signal at pin7 of the operational amplifier 620 can be connected using the diode D30 installed and R43 installed in a slightly different configuration to provide a function of MAP output signal clamping. In the MAP signal-clamping mode the MAP input signal is buffered by operational amplifier 620 at pin 1 and connected to the node of R43 and diode D30, which is then connected to the output resistor R44. The clamping mode allows operation of the vehicle MAP sensor input, which is intercepted by an external MAP relay and then output to the vehicle ECU via connection to pin 42 of connector 608. The output of operational amplifier 620 at pin 7 provides the clamping action in this mode to allow the MAP output signal to match the input MAP signal to a desired level and then be clamped to a maximum output value via diode D30 to pin 7 of operational amplifier 620. The ECU will not be allowed to see an over boost MAP signal as limited by the programmed value in the controller. The present embodiment uses the user assigned MAP output function that is programmed in the menu of the controller to output a MAP signal level to the ECU that is internally limited by the PWM value being limited, set by the parameters in the program menu. This mode eliminates the external Map relay but does require that the controller remain powered on all the time the vehicle is operating to provide the controller derived MAP output signal to the vehicle ECU.

The output PWM Water controls an optional water solenoid valve that is used to regulate the temperature of the propane mixer evaporator assembly to prevent excessively cold or hot temperature operation of the regulator. This output is a low frequency PWM of about 10-40 Hz at pin 11 of the connector 608, provided by a Smart-FET transistor that sinks current to ground when biased ON.

The PWM output signal used for driving the fuel control trim valve is at pin 12 of the microcontroller 602. This PWM is a frequency of about 20 KHz chosen for the best closed loop response of the trim valve with low ripple current at this frequency. The PWM output at pins 7 and 4 of the connector 608 is a push-pull output with all 4 of the Smart-FET transistors are installed on the control board. In addition, a second processor is required to provide gate drive with a programmed dead time period between the top and bottom transistors in the output bridge circuit. Microcontroller 640, a PIC18F1320, from Micro Chip is used to provide converting the PWM signal from the microcontroller 602 into two outputs with dead time control to the 3 Drivers 634, 636 and 638 of the 4 Smart-FETs. When all 4 of the transistors are installed the power supply for the topside transistors must be supplied as well, as these are isolated +15 volt supplies. A switch mode power supply section 624 is now described. Element 626 is an 8-pin current mode-switching controller IC that contains an output drive transistor to drive up to 1.25 amps, to drive the primary winding of transformer T2. T2 has 3 output winding sections that are isolated from one another. Two of the output windings provide the +15 volts gate drive to the optically isolated MOSFET gate drivers 636 and 638. The third winding of T2 provides +12 volts for feedback to the U3 switch mode controller IC 626 and also provides +12 volts, which is ground referenced to the bottom side bridge MOSFET driver IC 634. The Topside MOSFET drivers are of a type such as the optically isolated HCPL-3150, from Agilent Semiconductor. The bottom side driver is a dual driver of the type such as MC33152, from On-Semiconductor.

The topside drivers are not allowed to turn on after power is applied to the controller until the microcontroller has been reset and initialized to prevent any improper transistor turn-on during power on sequence or a microcontroller reset event. This control is provided by transistor Q5, a PNP signal transistor such as a 2N2907 type that is connected to the +5 volt on the emitter pin and which the base pin is biased from the microcontroller 602 at pin 11 via resistor R28. Unless pin 11 of the microcontroller 602 goes low, indicating power on sequence has been accomplished, the topside MOSFET drivers will not have bias voltage applied to the anode of each LED within drivers 636 and 638 to permit output drive. After bias has been supplied via Q5 collector to R35 and R29 to the anode of LED's in drivers 636 and 638, the PWM drive signal present at the same anode terminals will then allow the drivers to drive the top side Smart-FETs, Q1 and Q3, the same type as the Q2 transistor, a VNP14N04. By using TO-220 Smart-FETs in the bridge output circuit the output drive can be scaled for the servo actuator size or load requirement. The VNP14N04 allows up to 14 amperes output current, which is derated to about 6 amps with the potting compound providing heat sinking in the present enclosure used. Larger or smaller Smart-FETs are available for smaller loads or larger loads over 50 amps.

The use of the isolated power supplies to power the top side MOSFETS allows for the top transistors to be driven at 100% on if so desired, but the PWM is limited to between 98% and 2% duty cycle so that if the Smart-FETs were to shut off the fact that the input signal switches every cycle will try to reset the transistors if they have shut off. Since all four of the bridge transistors are Smart-FETs the output is protected from shorts to the battery positive or ground.

A power supply portion 628 of the controller consists of input reverse polarity protection, filtering and over voltage clamping. The battery input is supplied to the circuit via the input Schottky diode D1 and filtered by the multiple capacitor bank C1-C6, each a 330 microfarad 35 volt electrolytic capacitor. The input voltage is clamped by a transient surge absorber D2, a device such as a P6KE18, which clamps the input under 25 volts and allows the polyfuse in series with the input diode D1 to open circuit in the event of a large over voltage that causes more than 0.3 amps to flow through the polyfuse R1 and the surge absorber. The filtered voltage is then connected to two 5 volt LDO type voltage regulators, 630 and 632. The output of regulator 630 supplies +5 volt for the controller circuitry. The regulator 632 supplies +5 volt for the external sensors and is protected by a poly fuse F3, limiting the output current to under 0.145 amp, typically.

In the present approach, the switch mode controller 626 is used and is jumpered to supply +12 volts to the switch mode controller IC 626. The jumper J2A is installed to provide +12 volts to the switch mode controller IC 626 via input limiting resistor R72, a 10-ohm ½ watt resistor and clamped by the transient surge absorber/Zener diode D41 to clamp the driver voltage to about 18-20 volts.

While there have been illustrated and described particular embodiments of the present invention, it will be appreciated that numerous changes and modifications will occur to those skilled in the art, and it is intended in the appended claims to cover all those changes and modifications which fall within the true spirit and scope of the present invention.

What is claimed is:

1. A method of controlling the rate of flow of supplemental fuel to a air stream received by an engine, the method comprising:
sensing the operating characteristics of an engine;
determining an operational window, the operational window defining the optimum operating characteristics of the engine;
storing in a memory storage device a control map, the control map defining an amount of supplemental fuel to add based upon ranges of operating characteristics of the engine;
determining whether the sensed operating characteristics are within the optimum operating characteristics defined by the operational window; and
forming a control signal to vary the rate of supplemental fuel flow to a trim valve based upon whether the sensed operating characteristics are within the window and according to the control map.

2. The method of claim 1 further comprising increasing the supplemental fuel rate to the engine when the sensed operating characteristics remain within the operational window.

3. The method of claim 1 further comprising detecting when the operating characteristics are approaching a limit of the operational window.

4. The method of claim 3 further comprising decreasing the supplemental fuel rate as the sensed operating characteristics approach the limit of the operating window.

5. The method of claim 1 wherein the operating characteristics are chosen from the group of system activation, engine revolutions per minute (RPM), manifold absolute pressure (MAP), and accelerator pedal position.

6. A system for regulating the flow of supplemental fuel to an engine comprising:
a memory comprising a control map and an operating window; and
a controller coupled to at least one sensor and a flow trim valve such that the controller receives sensed operating characteristics from the at least one sensor and adjusts the fuel output rate of the flow trim valve according to the control map based upon a comparison of the sensed operating characteristics to the operating window.

7. The system of claim 6 wherein the operating characteristics include conditions indicative of system activation, engine RPM, manifold absolute pressure, and accelerator pedal position.

8. The system of claim 6 wherein the controller further comprises means for increasing the supplementary fuel rate to the engine when the operating characteristics remain within the operational window.

9. The system of claim 6 wherein the controller further comprises means for detecting when the sensed operating characteristics are approaching a limit of the operational window.

10. The system of claim 9 wherein the controller further comprises means for decreasing the fuel rate as the sensed operating characteristics approach the limit of the operating window.

11. A method of developing a target pressure comprising:
receiving a plurality of calibration values;
receiving a plurality of operating conditions;
scaling the operating parameters based on the calibration values; and
determining a target value to be applied to a trim valve based at least in part upon a stored fuel grid and the plurality of scaled operating conditions.

12. The method of claim 11 further comprising determining an operational window.

13. The method of claim 12 further comprising increasing the target pressure when the sensed operating conditions remain with the window.

14. The method of claim 12 further comprising detecting when the sensed operating conditions are approaching a limit of the window.

15. The method of claim 12 further comprising decreasing the target trim valve position as the sensed operating conditions approach the limit of the window.
